(19) United States
(12) Patent Application Publication
(10) Pub. No.: US 2019/0017411 A1
(43) Pub. Date: Jan. 17, 2019

(54) GAS TURBINE COMPRISING A WET COMPRESSION DEVICE FOR INTRODUCING A SURFACTANT LIQUID MIXTURE

(71) Applicant: Siemens Aktiengesellschaft, Munich (DE)

(72) Inventors: Gerhard Hülsemann, Oberhausen (DE); Nicolas Savilius, Essen (DE)

(73) Assignee: Siemens Aktiengesellschaft, Munich (DE)

(21) Appl. No.: 16/068,944

(22) PCT Filed: Nov. 9, 2016
(86) PCT No.: PCT/EP2016/077126

§ 371 Date: Jul. 10, 2018

(30) Foreign Application Priority Data
Jan. 20, 2016 (DE) 10 2016 200 678.9

(51) Int. Cl. F01D 25/00; F01D 25/12; F02C 7/143

(52) U.S. Cl. CPC F01D 25/007; F01D 25/12; F02C 7/1435; F05D 2300/51; F05D 2260/212; F05D 2260/95; F05D 2260/211

(57) ABSTRACT

A gas turbine having a wet compression device which allows droplets of an aqueous liquid mixture to be introduced into a compressor of the gas turbine during operation of the gas turbine, the aqueous liquid mixture containing at least one surfactant. The aqueous liquid mixture additionally contains at least a defoaming agent, and the gas turbine has a second metering device, which is designed to feed a predetermined quantity of defoaming agent into water which is provided for use in the wet compression device.

### CROSS REFERENCE TO RELATED APPLICATIONS

This application is the US National Stage of International Application No. PCT/EP2016/077126 filed Nov. 9, 2016, and claims the benefit thereof. The International Application claims the benefit of German Application No. DE 102016200678.9 filed Jan. 20, 2016. All of the applications are incorporated by reference herein in their entirety.

### FIELD OF INVENTION

The present invention relates to a gas turbine comprising a wet compression device, by means of which an aqueous liquid mixture in droplet form containing at least one surfactant can be introduced into a compressor of the gas turbine during the operation of the gas turbine. Moreover, the present invention relates to a method for operating a gas turbine of this kind.

### BACKGROUND OF INVENTION

In gas turbines of this kind with a wet compression device, water droplets are sometimes introduced into the intake air flow to boost the power output in order in this way to increase the working mass flow. To reduce or avoid erosion to the compressor blades, the droplet sizes in the wet compression device should be set so as to be as small as possible in order, on the one hand, to minimize the impact of the liquid water droplets on the surfaces of the compressor blades and to enable evaporation of the water droplets in the compressor air flow as quickly as possible.

The boost in the power output of the gas turbine resulting from wet compression can be explained by two main effects. Through the partial evaporation of the water droplets before entry to the compressor, the temperature of the air drawn in by the compressor decreases and hence its density increases. Since the compressor draws in a constant volume flow, the mass flow of air drawn in by the compressor increases. As a result, a correspondingly larger quantity of fuel can be added in the combustion chamber, and the turbine can extract a correspondingly higher power from the combustion gas. The first part of the boost in the power of the gas turbine is thus obtained. The second part of the boost in power is obtained from the “intercooling effect”. Here, the remainder of the water droplets evaporates on the way through the compressor and ensures continuous cooling of the working medium during compression. The specific work which has to be supplied for compression is thereby reduced and the power output of the gas turbine rises.

In some cases, it is possible to achieve a boost in power of over ten percent of the gas turbine power by means of the wet compression method. The water introduced into the intake air flow via the wet compression device is discharged again into the atmosphere with the exhaust gas after expansion in the expansion turbine and is therefore typically lost to additional processes.

A known disadvantage of the wet compression method consists in that, as already indicated above, there is increased erosion on the surface of the compressor blades. To this extent, the result is increased outlay on maintenance, thereby, in turn, giving rise to increased operating costs. However, erosion phenomena of this kind can be prevented or at least partially avoided by additional protective measures for the compressor blades or by the early replacement of the compressor blades. However, even these measures are associated with higher operating and maintenance costs and are unwanted by the operator. Further measures for reducing erosion on the surface of the compressor blades can, for instance, consist in limiting the operating time with the wet compression device, performing the introduction of the water into the intake air flow by means of suitable nozzles, thus ensuring that the droplets which enter the intake air flow are as small and uniformly distributed as possible, or even ensuring a sufficiently high supply pressure when introducing the water into the intake air flow.

However, all these measures are furthermore associated with economic sacrifices in the operation of the wet compression device. Limiting the operating time of the wet compression device, in particular, reduces the flexibility of the gas turbine and hence its usage capacity for the operator. A suitable choice of nozzles and/or a high supply pressure of the water can furthermore also not halt erosion phenomena but can only delay them somewhat in terms of time.

EP 1 557 539 A1 discloses a gas turbine comprising a compressor which contains a wet compression device, wherein the droplet size of an injected liquid is reduced by means of a surfactant.

### SUMMARY OF INVENTION

Thus, the technical object is to propose a gas turbine that is further improved, the operation of which with a wet compression device allows a reduction in the erosion phenomena on the compressor blades.

This object underlying the invention is achieved by a gas turbine and by a method as claimed concerning a gas turbine of the kind described above and also below.

The object underlying the invention is achieved by a gas turbine comprising a wet compression device, by means of which an aqueous liquid mixture in droplet form containing at least one surfactant can be introduced into a compressor of the gas turbine during the operation of the gas turbine, wherein the aqueous liquid mixture additionally contains at least a defoaming agent, wherein the gas turbine has a second metering device, which is designed to feed a predetermined quantity of defoaming agent into water which is provided for use in the wet compression device.

The object underlying the invention is likewise achieved by a method for operating a gas turbine of the kind described above and also below, wherein the aqueous liquid mixture is fed to the wet compression device.

At this point, it should be pointed out that surfactants are substances which reduce the surface tension of a liquid or the tension at the interface between two phases and allow or assist the formation of dispersions or act as solubilizers. Among the effects of surfactants is that two liquids which are immiscible per se, e.g. oil and water, can be intimately mixed.

It should furthermore be pointed out that the quantity of mixed or dissolved surfactants in the water can be set on an individual basis and, for instance, adapted according to operating conditions. The invention provides a group of surfactants in the aqueous solution, i.e. two or more surfactants.

According to the embodiment, a suitable open-loop and/or closed-loop control device is provided which adds the quantity of surfactant to the water for the wet compression device in accordance with the current operating state. In this case, an operating parameter of the gas turbine and/or of the wet compression device can be recorded by means of suitable sensors, for example, and processed by the open-loop and/or closed-loop control device.

According to the invention, therefore, provision is made to operate the wet compression device with an aqueous liquid mixture which contains at least one surfactant. Since the surfactant has the property of reducing the surface tension of the water, the water droplets can be atomized more easily or break up into even smaller droplets, with a lower transfer of momentum, when they strike the surfaces of the compressor blades. It is furthermore advantageous that the formation of relatively large droplets, e.g. on constituents of the intake gas, can be largely prevented. By virtue of the relatively improved atomization or the lower transfer of momentum of a liquid droplet on the surface of the compressor blades, it is also possible to reduce erosion during operation of the wet compression device.

Another advantageous side effect of operating the wet compression device with the aqueous liquid mixture also consists in improved cleaning of the compressor. This results from the fact that surfactants typically also have a greater washing activity and are therefore also better suited to washing out contaminants in the compressor in comparison with pure water.

In the context of the invention, it is envisaged, in particular, that the aqueous liquid mixture additionally contains at least a defoaming agent. In this case, the quantity of mixed or dissolved defoaming agent is also set on an individual basis and for it to be adapted depending on the operating state. Moreover, it is advantageous to provide two or more defoaming agents in the liquid mixture.

At this point, it should be pointed out that defoaming agents are chemical formulations with a distinct interfacial activity, which are suitable for suppressing unwanted foaming (e.g. during wastewater purification, paper production, during the washing process in washing machines, during painting, during fermentation processes etc.) and breaking foam that has already formed.

Thus, the defoaming agent ensures that foaming can to a large extent be avoided, e.g. during the passage of the aqueous liquid mixture through a nozzle or upon impact with the surfaces of the compressor blades. In other words, the defoaming agent can prevent clogging of the compressor with foam. As tests by the applicant have shown, the defoaming agent has little or no effect on the reduced surface tension of the water in the liquid mixture brought about by the surfactants.

The turbine has a second metering device, which is designed to feed a predetermined quantity of defoaming agent into water which is provided for use in the wet compression device. The second metering device is designed to ensure introduction of the quantity of defoaming agent into water in a manner dependent on operation.

According to another embodiment of the invention, it is envisaged that the gas turbine has a first metering device, which is designed to feed a predetermined quantity of surfactant into water which is provided for use in the wet compression device. Thus, the first metering device enables a suitable quantity of surfactant to be added to the water for the wet compression device, and it therefore selectively influences the atomization behavior or impact behavior and hence the erosion by the aqueous liquid mixture in the compressor of the gas turbine, for example. In particular, the quantity of surfactant which is added to the water is set in accordance with an operating state of the gas turbine. For this purpose, the typical practice is to record suitable operating parameters by means of sensors (not described specifically) and to process them by means of a closed-loop and/or open-loop control unit to an extent which allows a suitable quantity of surfactant for the water to be calculated therefrom.

In respect of other technical features, the second metering device is substantially identical to the first.

According to another embodiment, it is envisaged that the at least one surfactant is selected from the following group of surfactants: polyalkylene glycol ether, polysorbate20, alkyl polyglycosides; these substances are not only well-suited for mixing with water but also have a high capacity for reducing the surface tension of the water. It is likewise found that these substances can themselves be destroyed after flowing through the hot-air gas in the gas turbine, especially in the combustion chamber region, and therefore substances that are largely harmless to the environment are found in the exhaust gases.

According to another embodiment of the invention, it is envisaged that the at least one defoaming agent is selected from the following group of defoaming agents: tri-n-butyl phosphate, monoglycerides, diglycerides; in aqueous compositions, these substances exhibit a high capacity for suppressing the formation of foam and are broken down into largely harmless substances after passing through the hot-air gas in the gas turbine.

According to another embodiment of the method according to the invention, provision can be made to provide an open-loop and/or closed-loop control device which, in accordance with the current operating state of the gas turbine, adds the quantity of surfactant or defoaming agent to water provided for the operation of the wet compression device. As already explained above, the respectively added quantity can be determined by means of suitable sensors, which record an operating parameter of the gas turbine, which is appropriately processed by the open-loop and/or closed-loop control device.

The invention will be explained specifically in greater detail below with reference to individual figures. It should be pointed out here that the figures should be interpreted as being merely schematic and, in particular, that no restriction in terms of implementation results therefrom.

It should furthermore be pointed out that the technical function of the technical features which have the same reference signs is intended to correspond.

It should furthermore be pointed out that the technical features described below are claimed in any desired combination with one another, and also in any desired combination with the above-described embodiments of the invention, to the extent that the combination resulting therefrom can achieve the object underlying the invention.

### BRIEF DESCRIPTION OF THE DRAWINGS

In the drawing:

FIG. 1 shows a first embodiment of the gas turbine according to the invention in a schematic circuit diagram;

FIG. 2 shows a schematic circuit diagram of a second embodiment of the gas turbine according to the invention.

### DETAILED DESCRIPTION OF INVENTION

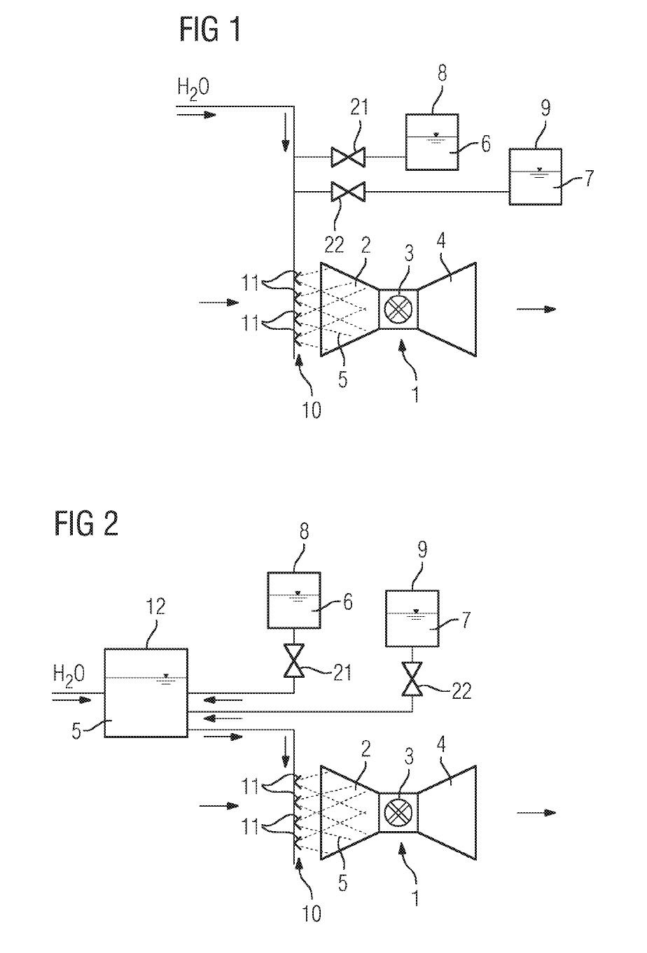

FIG. 1 shows a first embodiment of a gas turbine 1 according to the invention in a schematic circuit diagram. The gas turbine 1 comprises a wet compression device 10, by means of which an aqueous liquid mixture 5 can be introduced into the compressor 2 of the gas turbine 1 via nozzles 11. In this case, the aqueous liquid mixture 5 is sprayed directly into the intake air flow during the operation of the gas turbine 1, wherein the aqueous liquid mixture 5 is atomized into relatively small droplets. The aqueous liquid mixture 5 is then increasingly evaporated in the compressor, with the result that, after a certain compressor stage, there is no longer any more liquid mixture but only the evaporated form thereof. This is compressed together with the intake air and fed to the combustion chamber 3 for combustion with a fuel (not designated specifically). The hot gas mixture thus formed is expanded via the expansion turbine 4 and then discharged from the latter.

In order then to ensure that the liquid mixture is atomized into relatively small liquid droplets, the present embodiment of the gas turbine 1 envisages supplying the wet compression device 10 with an aqueous liquid mixture 5 which contains at least one surfactant 6 and at least one defoaming agent 7. The surfactant 6 is stored in a first container 8 and, depending on requirements, can be added via a first metering device 21 to the water provided for operation in the wet compression device. Here, the first metering device 21 can also be switched by means of an open-loop and/or closed-loop control unit, which takes into account current operating parameters of the gas turbine 1 when setting the quantity of surfactant.

Likewise, the quantity of defoaming agent 7 can be set by means of a second metering device 22. The defoaming agent 7 is stored in a second container 9, wherein defoaming agent can be fed into the water from this as required, said water being provided for use in the wet compression device 10.

Owing to the introduction of a surfactant, the surface tension of the water which is atomized by means of the nozzles 11 in the wet compression device 10 then falls. Through the reduction of the surface tension, it is thus possible, on the one hand, to achieve improved atomization and, on the other hand, bursting of the water droplets formed on the surface of the compressor rotor blades can take place with a reduced transfer of momentum. Since the droplets are of a relatively smaller size than, for instance, in comparison with a wet compression device without the admixture of surfactant, the evaporation of the water or liquid mixture introduced into the compressor 2 also takes place more quickly, and the erosion phenomena on the surface of the compressor blades can be reduced. As already explained above, the defoaming agent 7 serves primarily for the avoidance of clogging of the compressor 2 by the formation of foam.

FIG. 2 shows another embodiment of the gas turbine 1 according to the invention, which differs from the embodiment shown in FIG. 1 in that the surfactant 6 and/or the defoaming agent 7 is/are not provided in the region of the feed line of the wet compression device 10 for the nozzles 11; instead, the nozzles 11 are supplied centrally directly from a storage container 12, into which water, surfactant 6 and defoaming agent 7 are introduced for the purpose of mixing with one another. The storage container 12 thus contains a suitable aqueous liquid mixture 5 which has already been fully mixed and which can be withdrawn and fed to the nozzles 11 of the wet compression device 10 without further chemical conditioning. The quantity of surfactant 6 and of defoaming agent 7 can each be set by a first metering device 21 and a second metering device 22, wherein the respective metering devices 21, 22 enable a predetermined quantity of surfactant 6 to be withdrawn from the first container 8 or of defoaming agent 7 to be withdrawn from the second container 9.

Further embodiments of the invention will become apparent from the dependent claims.

1.-7. (canceled)

8. A gas turbine comprising:
a wet compression device, by means of which an aqueous liquid mixture in droplet form containing at least one surfactant is introduced into a compressor of the gas turbine during the operation of the gas turbine, wherein the aqueous liquid mixture additionally contains at least a defoaming agent, and
a second metering device, which is designed to feed a predetermined quantity of defoaming agent into water which is provided for use in the wet compression device.

9. The gas turbine as claimed in claim 8, further comprising:
a first metering device, which is designed to feed a predetermined quantity of surfactant into water which is provided for use in the wet compression device.

10. The gas turbine as claimed in claim 8,
wherein the at least one surfactant is selected from the following group of surfactants: polyalkylene glycol ether, polysorbate20, alkyl polyglycosides.

11. The gas turbine as claimed in claim 8,
wherein the at least one defoaming agent is selected from the following group of defoaming agents: tri-n-butyl phosphate, monoglycerides, diglycerides.

12. A method for operating a gas turbine as claimed in claim 8, comprising:
feeding the aqueous liquid mixture to the wet compression device.
